(19) United States
(12) Patent Application Publication
(10) Pub. No.: US 2013/0262343 A1
(43) Pub. Date: Oct. 3, 2013

(54) Online Secondary Market for Tax Liens

(71) Applicant: LIENMARKET, LLC, Fort Lee, NJ (US)

(72) Inventor: Igor Kirtchakov, Fort Lee, NJ (US)

(73) Assignee: LienMarket, LLC, Fort Lee, NJ (US)

(21) Appl. No.: 13/851,490

(22) Filed: Mar. 27, 2013

Related U.S. Application Data
(60) Provisional application No. 61/616,754, filed on Mar. 28, 2012.
(60) Provisional application No. 61/730,662, filed on Nov. 28, 2012.

(51) Int. Cl. G06Q 40/06

(52) U.S. Cl. CPC G06Q 40/06
USPC 705/36 T

(57) ABSTRACT

An electronic, online, secondary marketplace for tax liens in which a marketplace server receives details of a tax-lien certificate put up for sale by a certificate owner. The owner supplies certificate details including the amount of taxes, penalties, premiums and interest currently due, an interest rate associated with the certificate, the property on which the lien is secured, the expiry date of the redemption period of the certificate, and an asking price. On request from a second user, the certificate details are sent to them. The second user may submit a bid price. If the bid price is acceptable to the first user, beneficial ownership of the tax-lien certificate is transferred to the 2^{nd} user upon payment of the agreed price, and completion of legal formalities. If not, an auction bidding process may continue until a price is agreed upon, or one party drops out of the auction.

### CLAIM OF PRIORITY

This application claims priority to U.S. Provisional Application No. 61/616,754 filed on Mar. 28, 2012 and to co-pending U.S. Provisional Application No. 61/730,662 filed on Nov. 28, 2012, the contents of both of which are fully incorporated herein by reference.

### FIELD OF THE INVENTION

This invention relates to a system and method for creating electronic, online marketplaces for securities, and more particularly, to creating a system and method for an electronic, online secondary marketplace for liens, such as, but not limited to, property backed liens.

### BACKGROUND OF THE INVENTION

A lien is a legal claim of one entity upon the property of another entity to secure payment of a debt.

One form of lien is a tax lien that may be taken out by a representative government of a jurisdiction against a property owner within the jurisdiction fails to pay taxes due to the representative government. For instance, a state, county or municipality may invoke a tax lien against a property owner in that state, county or municipality who is delinquent on their property taxes, i.e., they have failed to pay taxes due on their property. A tax lien for property taxes is generally secured by the property on which the taxes are owed, meaning that if the property tax is not paid, the holder of the tax lien may foreclose on the property, and take possession of it. As a tax lien is a first position lien, it takes precedence over all other liens such as, but not limited to, mortgage liens. Most states have laws regarding foreclose that typically require various procedures designed to give the property owner time to redeem the tax lien, typically through payment of the outstanding taxes, plus interest, penalties and premiums. These procedures are designed so that there is typically a time period of about 18 to 24 months between a tax lien being issued on a property, and the property securing the tax lien is foreclosed on. Most jurisdictions need the tax revenues for immediate spending and are typically not interested in becoming property owners. To obtain the revenues, the jurisdictions may auction the tax liens. These tax liens are typically open, public auctions in which anyone has the opportunity to acquire a tax lien. A tax-lien auction typically requires the buyer of the tax lien to pay the taxes due immediately, plus a premium, and then has the right to either collect the taxes due plus an agreed interest or to foreclose on the property securing the lien. Most states have a limit on the interested that can be charged on tax liens, though that limit is typically high, and may, for instance, be in the region of 18% per annum. In many states, the bidding at a tax lien auction is a bid on the interest rate the purchaser is willing to charge, with the lowest interest rate bidder being the winner. The new owner of the tax lien is also obligated to pay future taxes as they become due, but is also entitled to collect interest on those extra payments from the time of their payment.

FIG. 1 is a schematic flow diagram of how a typical tax lien auction arises and occurs.

In step 1001, an entity owns taxable property in a jurisdiction allowing tax lien sales. The entity may be any legal entity such as, but not limited to, an individual, a married couple, a partnership or a corporation. The taxable property may be any real estate, such as, but not limited to, land, a building, or a combination thereof, located in, or subject to the control of, a jurisdiction such as, but not limited to, a township, a county, or a state, that has laws allowing the use of, and the sale of, tax liens.

In step 1002, the entity becomes delinquent on property tax, i.e., they fail to pay taxes due to the jurisdiction in a timely manner. The taxing jurisdiction can apply pressure to obtain the taxes due by taking out a tax lien against the property, essentially saying that they will foreclose on the property, and take ownership of it if the taxes are not paid. Taking ownership of property is, however, a complex task and states have a redemption period which is a time between when a lien on real estate is issued and when foreclosure can be undertaken. This redemption period is usually about 16 to 24 months. The taxing jurisdiction may, however, be keen to get the taxes owed to them as soon as possible. In jurisdictions where it is allowed, they may then move to step 1003: Legal jurisdiction auctions lien on entire taxable property.

The details of auctions vary from state to state, but are typically open to the public and the bidding is typically on the interest rate the bidder is willing to charge on the money owed.

In step 1004, a 3^{rd} party entity wins the auction by being the lowest bidder in an interest rate bid, or the highest bidder in a premium bid. In winning the auction, the 3^{rd} party agrees to immediately pay outstanding taxes, interest and penalties owing to the taxing jurisdiction, and assumes the responsibility of paying future taxes on the property as they become due on the property.

In return, the winning 3^{rd} party is given a tax lien certificate, entitling them to collect all the taxes, interest and penalties due, plus interest at the agreed rate on what the third party paid to the taxing jurisdiction, including interest on later paid taxes from the time they are paid. They also assume the right to foreclose on the property at the end of the redemption period. As a tax lien is a first position lien, that foreclosure would nullify all other liens on the property including mortgage liens. As the redemption costs are typically much smaller than the value of the property, about 95% of tax liens are redeemed rather than foreclosed and usually by the entity having a mortgage lien on the property.

The owner of the tax lien certificate may then loop through step 1005 of paying further property taxes as they become due, typically quarterly, until every quarter, until one of three events occurs:

Step 1009: The redemption period expires and the tax lien owner begins foreclosure proceedings. In practice this is the least likely outcome, happening in only about 5% of actual cases. If it does occur, it means that the tax lien certificate holder may proceed to step 1010 and become the owner, free of all other liens, of a property for what is often a fraction of the value of the property.

Step 1006: Party with 2nd position rights, or the original owner, redeems the tax lien. This is the most common outcome, and means that the tax lien certificate buyer proceeds to step 1007 and collects a profit.

Step 1008: Sell tax lien to 4th party. This would be a perfectly good option, allowing the tax lien certificate buyer to proceed to step 1007 and collect a profit, but is hampered in practice, largely due to a lack of a liquid secondary market in tax lien certificates, a situation that this invention aims to change.

The combination of high rates of fixed interest secured by assists whose value typically far exceeds the value of the lien make tax liens a highly desirable investment instrument. As there are typically secondary liens, such as mortgage liens on properties, owned by large corporations, most tax liens are redeemed and do not go to foreclosure, so the vast majority of tax lien investments generate income without any need to get involved in foreclosure proceedings or property ownership.

The present invention aims to make tax liens an even more attractive investment instrument by helping establishing a liquid secondary market in tax lien certificates, along with the tools necessary to evaluate and manage a portfolio of tax liens.

### DESCRIPTION OF THE RELATED ART

The relevant prior art involving security markets includes:

U.S. Pat. No. 6,161,099 issued to Harrington et al. on Dec. 12, 2000 entitled “Process and apparatus for conducting auctions over electronic networks” that describes an apparatus and process for conducting auctions, specifically municipal bond auctions, over electronic networks, particularly the Internet, is disclosed. The auctioneer maintains a web site from which information about bonds to be auctioned can be obtained. A user participates in the auction by accessing the web site via a conventional Internet browser and is led through a sequence of screens that perform the functions of verifying the user's identity, assisting the user in preparing a bid, verifying that the bid conforms to the rules of the auction, displaying to the user during the course of the auction selected bid information regarding bids received and informing the bidder how much time remains in the auction. The user may be given the option of confirming the accuracy of his bid before submitting the bid. The auctioneer is able to review bidding history, determine the winner and notify the winner over the network, and display selected auction results to bidders and observers over the network.

U.S. Pat. No. 7,085,740 issued to Meyers on Aug. 1, 2006 entitled “Method and apparatus for conducting auctions” that describes a method and system for conducting an on-line auction, in which the bidding is weighted to encourage early and higher bidding. Each time a buyer places a new high bid on an item he is accorded points, weighted to reflect the amount of the bid, either as an absolute value as a relative increase in the high bid compared to prior bids, or in some other fashion. The bid may also be weighted to reflect how long the bid stays the high bid. Thus the bidder is encouraged to place a bid early to have the high bid for as long as possible, and outbid others, so that he does not lose his position as the-high bidder. The invention therefore results in higher bidding, for items offered for sale and yields a more fair and accurate test of the true worth of the item offered for sale.

US Patent Application 20060020541 issued to Gommlich on Jan. 26, 2006 entitled “System and method for automated title searching and reporting, reporting of document recordation, and billing” that describes a method and system for automated title searching and reporting, having one or more generally geographically located computers each having software and one or more databases; an interface for receiving instructions from one or more clients setting forth desired title information for one or more pieces of property such that the interface determines which of said computers to which to send the received instructions and communicates those instructions; searching and gathering data concerning the desired title information from a multiplicity of locations including regional records (from county clerk(s)), an intranet or the Internet; each of the computers via its software, presenting one or more screens for interpolation of data concerning said desired title information; interpolating the data into one or more screens; storing the interpolated data on one of the database(s); and transmitting the interpolated data to the proper client. Additionally, the method and system provides for logging each of its uses, archiving the data, providing access to the archived data by the proper client, reporting the recordation of documents relating to title information, management of all the data and billing the proper client and/or examiner (or user) for the use of the method and system in the manner proscribed, and facsimile transmission either by way of fax software or by hard copy.

US Patent Application 20060064375 issued to Campagna et al. on Mar. 23, 2006 entitled “Method and system for creating and maintaining records of title for items of property” that describes a method and system for recording a transaction affecting title to an identified item of property and for maintaining a record of title for such item of property. The system includes a title security device and a title record management system. The title security device includes: a) input means to the device for input of transaction information relating to a transaction; b) a data store storing a signing key for digitally signing documents; and c) a programmable controller communicating with the title record management system. The controller is programmed to control the title recording system to: a) input the transaction information; b) generate a document representative of changes in the title resulting from the transaction; and c) digitally sign the document with the signing key. The title record management system includes: a) a database, the database including an initial record for the item of property; and b) a programmable record system controller communicating with the title security device. The record system controller is programmed to control the title record management system to: a) receive a digitally signed document representative of changes in the title resulting from the transaction; b) verify the document's signature; and c) update the record of title for the item of property in accordance with the document if the signature is determined to be valid.

Various implements are known in the art, but fail to address all of the problems solved by the invention described herein. One embodiment of this invention is illustrated in the accompanying drawings and will be described in more detail herein below.

### SUMMARY OF THE INVENTION

The present invention relates to a system and method for providing an electronic, online, secondary marketplace for tax liens.

In a preferred embodiment, a marketplace server may be functionally connected to a portfolio database and to a communications network. The marketplace server may receive certificate details of a tax-lien certificate from a first user via a communications network.

The first user may, for instance, be the beneficial owner of the particular tax-lien certificate, or an authorized agent of the beneficial owner. The certificate details may, for instance, include information such as, but not limited to, the amount of taxes, penalties, premiums and interest currently due to the beneficial owner on redemption of the tax-lien certificate and an interest rate associated with the certificate. The information may also include details concerning the property on which the lien is secured, and which may be necessary or useful in evaluating it as a collateral for the tax lien, such as, but not limited to, the location of the property, an assessment of its market value, and of any other information relevant to the property that may affect its standing as security against the tax lien. The information regarding the tax-lien certificate may further include details such as, but not limited to, an expiry date of a redemption period of the certificate, and a first asking price to buy the tax-lien.

In a preferred embodiment, the marketplace server may then automatically store some or all of the details received regarding the particular tax-lien certificate on one or more portfolio databases.

The marketplace server may then, on receiving an appropriate request from a second user, deliver a summary of the certificate details to that second user, provided the second user is properly authenticated. The summary details sent to the second user may be a subset of all the details received from the first user and may, for instance, include, but are not limited to, an amount of taxes and interest currently due to the beneficial owner on redemption of that particular tax-lien certificate, an interest rate associated with the certificate and a location of a property on which the tax-lien is secured.

In a preferred embodiment, the marketplace server may then receive a bid price from the second user, indicating the price they are interested in paying for the tax-lien certificate. After storing the bid price, and any other relevant information regarding the second user and their bid price, on the portfolio database or other relevant storage media, the marketplace server may then automatically deliver relevant details of the bid price to the first user via the communications network.

If the bid price is acceptable to the first user, the marketplace server may then automatically generate a transaction agreement effectively transferring beneficial ownership of the tax-lien certificate to the 2^{nd} user upon payment of the agreed price, and completion of any legal formalities that may be necessary.

If the bid price is not acceptable to the first user, they may either withdraw from the auction or make a counter offer. The first and second user may continue this process of offering counter bids via the marketplace server over the communications network until an agreement is reached, or one of the parties withdraws.

Therefore, the present invention succeeds in conferring the following, and others not mentioned, desirable and useful benefits and objectives.

It is an object of the present invention to provide an electronic, secondary market in fixed rate securities, and in particular, in tax-lien certificates.

It is another object of the present invention to provide users access to tools necessary to evaluate tax-liens.

Yet another object of the present invention is to provide such tools either in exchange for a membership fee or for per-use charges, or some combination thereof.

### BRIEF DESCRIPTION OF THE DRAWINGS

FIG. 1 shows a schematic flow diagram of some steps in an exemplary process of acquiring and maintaining a tax lien certificate.

FIG. 2 shows a schematic view of an exemplary embodiment of an online, electronic auction system for use in a secondary tax lien certificate market.

FIG. 3 shows a value/investment total over time for an exemplary tax-lien certificate.

FIG. 4 shows an effective interest rate over time for an exemplary tax-lien certificate.

FIG. 5 shows a flow diagram of an exemplary tax lien certificate auction.

### DESCRIPTION OF THE PREFERRED EMBODIMENTS

The preferred embodiments of the present invention will now be described with reference to the drawings. Identical elements in the various figures are identified with the same reference numerals.

Various embodiments of the present invention are described in detail. Such embodiments are provided by way of explanation of the present invention, which is not intended to be limited thereto. In fact, those of ordinary skill in the art may appreciate upon reading the present specification and viewing the present drawings that various modifications and variations can be made thereto.

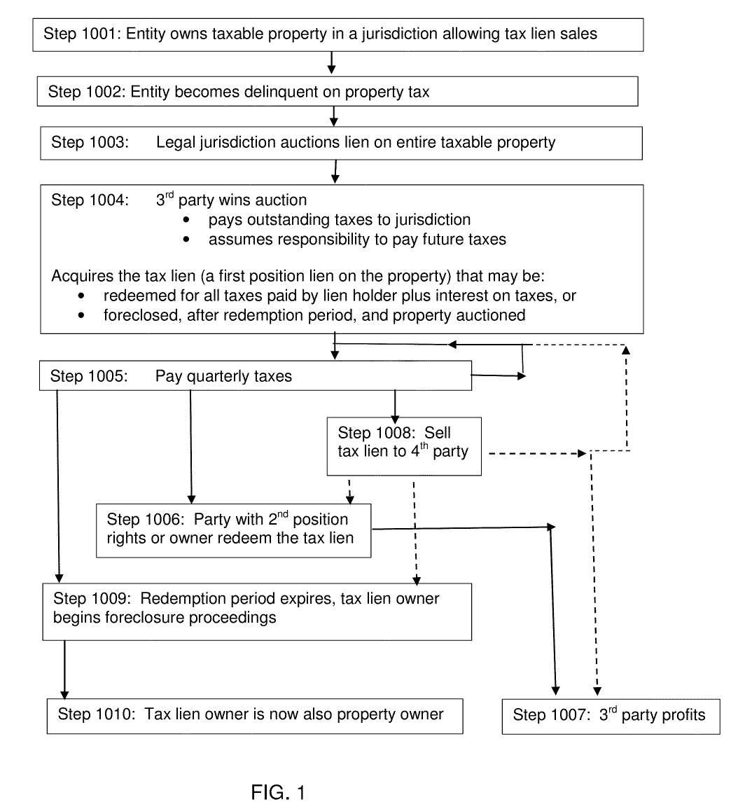

FIG. 1 shows a schematic flow diagram of some steps in an exemplary process of acquiring and maintaining a tax lien certificate, and is described in detail above in the “Background” section of this specification.

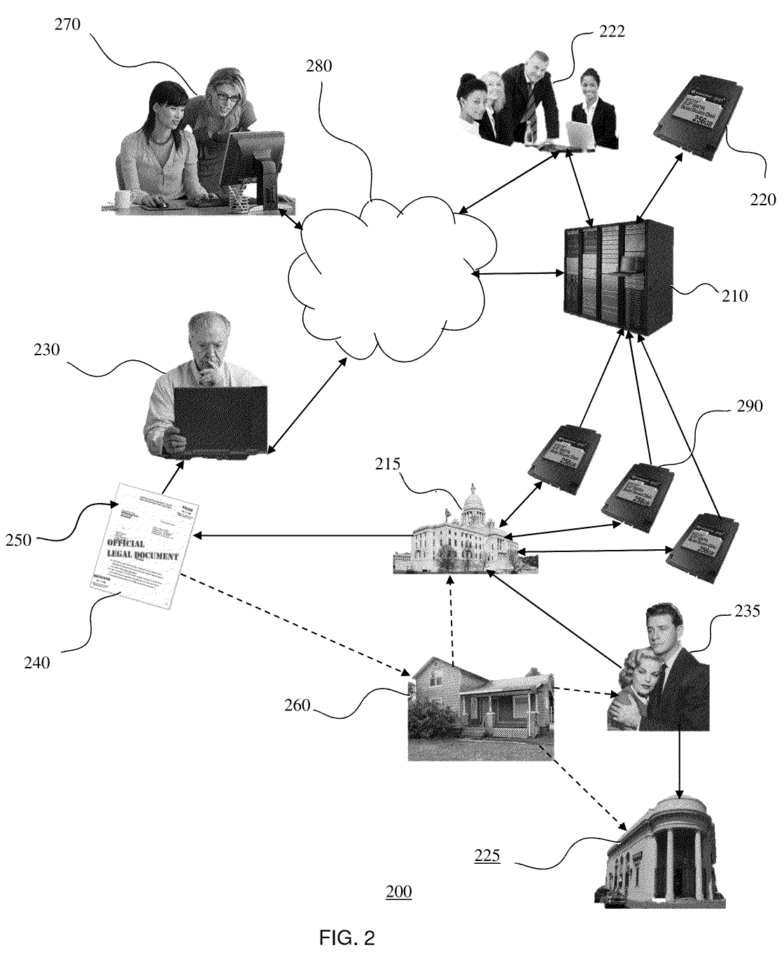

FIG. 2 shows a schematic view of an exemplary embodiment of an online, electronic auction system for use in a secondary tax lien certificate market.

As shown, a first user 230 may have acquired beneficial ownership of a tax-lien certificate 250. This beneficial ownership may, for instance, have been acquired at an auction run by a particular jurisdiction 215.

The particular jurisdiction 215 may for instance be a governing entity such as, but not limited to, a state, a county or a municipality. A party 235 having a mortgage on a property 260 located within the jurisdiction may owe property related taxes to the particular jurisdiction 215.

As described in detail above in connection with FIG. 1, the particular jurisdiction 215 may obtain a tax lien against the party having beneficial ownership of the property 235 in an attempt to obtain the taxes due to them. Such a tax lien, if not redeemed, entitles the particular jurisdiction 215 to foreclose on the property 260, and take possession of it free of any claims on the property by persons or entities, such as, but not limited to, a party having a mortgage-lien on the property 225.

As explained before, however, foreclosing on a property is typically neither simple nor quick. States usually have a redemption period, often as long as two years, in which the holder of the tax-lien may be required to wait before beginning final foreclosure proceedings may begin. In order to obtain the taxes due them, the particular jurisdiction 215 may, if local law permits, auction the tax lien certificate at a public auction to a first user 230 who may be, but is not limited to, a private individual, a partnership, a corporation, or some combination thereof.

Details of such auctions may vary from state to state, but are typically open to the public and the bidding is typically on the interest rate the bidder is willing to charge on the money owed.

A first user 230 may, for instance, have obtained beneficial ownership of the tax-lien certificate 250 by being the lowest bidder in an interest rate bid, or the highest bidder in a premium bid auction.

As beneficial owner of the tax-lien certificate 250, the first user 230 may agree to immediately pay all outstanding liabilities due by the party having beneficial ownership of the property 235 to the particular jurisdiction 215 such as, but not limited to, delinquent property taxes and interest and penalties owing on those delinquent taxes. The first user 230 also assumes the responsibility of paying future taxes on the property as they become due.

In return, the first user 230 obtains a tax lien certificate 250, entitling them to collect all moneys paid to the particular jurisdiction 215 to obtain the tax-lien certificate 250 plus interest on all that money at the agreed rate which the first user 230 bid to win the auction. The maximum interest rate allowed may be set by the state, and is typically in the region of 18%. The first user 230 is also entitled to interest, at that same rate, on later paid taxes from the time they are paid. They also assume the right to foreclose on the property at the end of the redemption period. As a tax lien is a first position lien, that foreclosure would nullify all other liens on the property including mortgage liens. As the redemption costs are typically much smaller than the value of the property, about 95% of tax liens are redeemed rather than foreclosed and usually by the entity 225 having a mortgage lien on the property.

The tax lien certificate may be redeemed at any time during the redemption period, or not at all.

In the event that the first user's 230 financial circumstances or objectives during the redemption period, and the first user 230 decides to liquidate their tax-lien certificate 250, they currently have limited options.

The current invention is intended to offer such an owner of a tax lien the offer to auction their tax-lien certificate 250 in a liquid market.

A liquid market typically requires a number of attributes such as, but not limited to, a sufficient number of buyers and a standardized way of valuing the item being traded on the market.

Widespread availability of a communications network 280 such as, but not limited to, the Internet, has made aggregating sufficient potential buyers and sellers to a market in any suitable commodity relative easy and inexpensive. Problems with trading tax lien certificates include, but are not limited to, the amount of data required to evaluate a certificate, and the task of performing the evaluation. Although the tax-lien certificate 250 may contain relevant certificate details 240 such as, but not limited to, the amount paid for the certificate, the rate of interest due, estimates and timing of future taxes due, the date on which the redemption period ends, and the location of the property serving as collateral on the lien, it may not always contain a complete set of data to make a thorough evaluation of the value of the tax-lien certificate 250. Other data that may be relevant to valuing the lien may include, but is not limited to, state laws regarding liens and foreclosures, a market evaluation of the value of the property, zoning laws applicable to the property or in the process of becoming applicable, details of the beneficial owners including their financial standing, the identity and details of beneficial secondary lien holders, their financial standing and their history of redemption of similar properties. Although all this information may be publically available it may be tedious to collect and evaluate.

An investment facilitating company 222 may make a secondary market available at several levels.

The investment facilitating company 222 may, for instance, simply act as a brokerage firm operating a marketplace server 210 that allows users to post certificate details 240 of tax-lien certificates 250 they wish to dispose of on a website for other users to bid on. Such a group may simply make money by taking a fee or a percentage for each trade, or may charge people a membership fee to participate in trading on the website or some combination thereof.

The investment facilitating company 222 may be more proactive and provide potential buyers and sellers with more information that may be obtained from 3rd party data bases 290 such as, but not limited to, county, state and municipal records and websites. This information may, for instance supplement information related to the other elements of the tax-lien certificate 250 that may not be explicit on the certificate details 240, but may be relevant to an evaluation of the certificate. This information may, for instance, be include data such as, but not limited to, the identity, financial standing and past behavior of other entities having an interest in the tax lien such as, but not limited to, the party having beneficial ownership of the property 235, the party having a mortgage-lien on said property 225 and the particular jurisdiction 215. The data may also include further information regarding the property 260 that may be the collateral for the tax lien, such as, but not limited to, value assessments, inspection reports, code compliance reports, records of past transactions involving the property, assessments of the neighborhood surrounding the property, valuations of comparative properties in the same or comparative neighborhood, and relevant news articles regarding the property or the neighborhood or some combination thereof.

This additional information may be made available, in whole or in part to either the first user 230 or to the second user 270 or both, either on a fee basis, or a membership bases or a combination thereof. The investment facilitating company 222 may choose to store some or all of such data on one or more portfolio databases 220 that they control or have access to.

The investment facilitating company 222 may also process some or all of such data relevant to a particular tax-lien certificate 250 to arrive at a value or a partial value or a categorization of the value or risk associated with owning the tax-lien certificate 250, and may make such data available to either a potential buyer or a potential seller of a tax-lien certificate 250. The availability of the data may be on a per use fee, a subscription bases, a tiered membership basis, or some combination thereof.

The investment facilitating company 222 may also or instead use such data to advise users or for their own use in acting as buyers or sellers of such certificates.

The investment facilitating company 222 may also or instead make such data available to users for their own analysis on terms such as those described above.

The investment facilitating company 222 may in addition to, or instead of facilitating auctions of tax-lien certificates 250, provide services regarding the transfer of ownership of one user to another, such as, but not limited to, providing customized legal transfer documents, overseeing escrow accounts while resolving an agreed transaction, storing transaction records or some combination thereof.

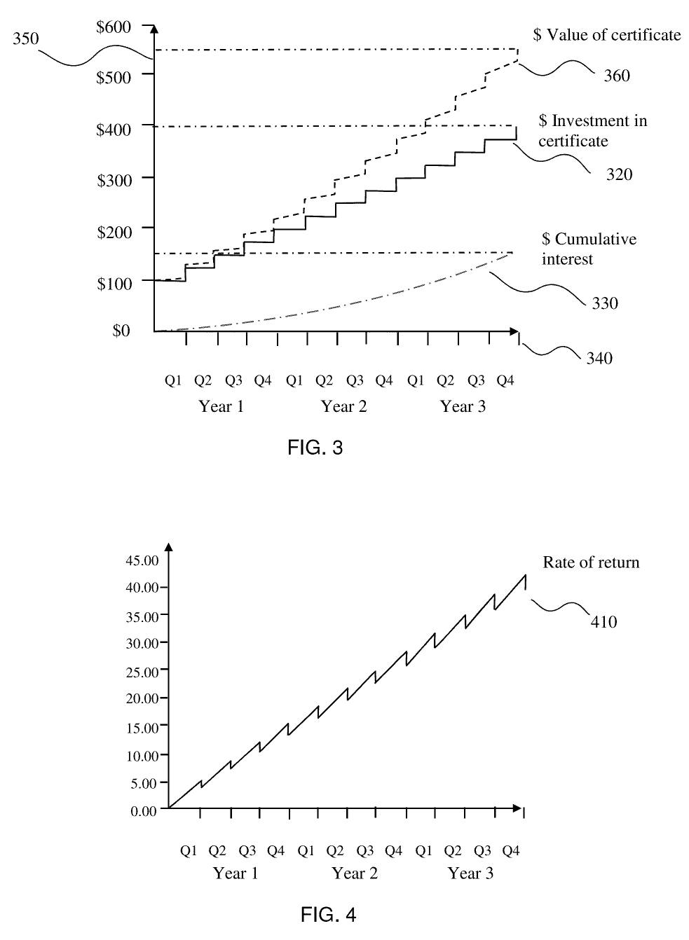

FIG. 3 shows a value/investment total over time for an exemplary tax-lien certificate. There graphs are plotted of value in dollars along the Y axis 350, versus time in years along the X axis 340. The X axis 340 has each year divided into four quarters. This is a typical periodicity of the collection of property taxes.

The solid line is a plot of a total investment 320 in a tax-lien certificate 250 against time. In this example, the initial investment is shown as $100. This represents the total amount paid by a buyer at a tax lien auction. At the end of each quarter, the plot of a total investment 320 increases by $25. This is representative of a property tax that is due quarterly and is the responsibility of the beneficial owner of the tax-lien certificate 250. The total investment 320 in the tax-lien certificate 250 therefore increases in a step like fashion over time.

The dot-dash line is a plot of a cumulative interest due 330 in dollars over time. Although the nominal interest rate on the certificate is fixed at a percentage that is typically in the range of 0-18%, the cumulative interest due 330 increases exponentially with time. This increase is because the interest is changed on the total investment 320 so that the principal on which interest is being charged increases with each quarterly tax payment and is compounded on the tax due.

The dotted line represents a total value of the certificate 360. The total value of the certificate 360 is the total amount of taxes, penalties, premiums and interest currently due and is the sum of the total investment 320 and the cumulative interest due 330.

FIG. 4 shows a plot of an effective rate of return on investment 410 over time for an exemplary tax-lien certificate. The effective rate of return on investment 410 has a saw-tooth structure representing the fact that immediately after the payment of the quarterly tax, total investment 320 takes a step wise increase, so that the ratio of total value of the certificate 360 over a plot of a total investment 320 takes a step wise descent.

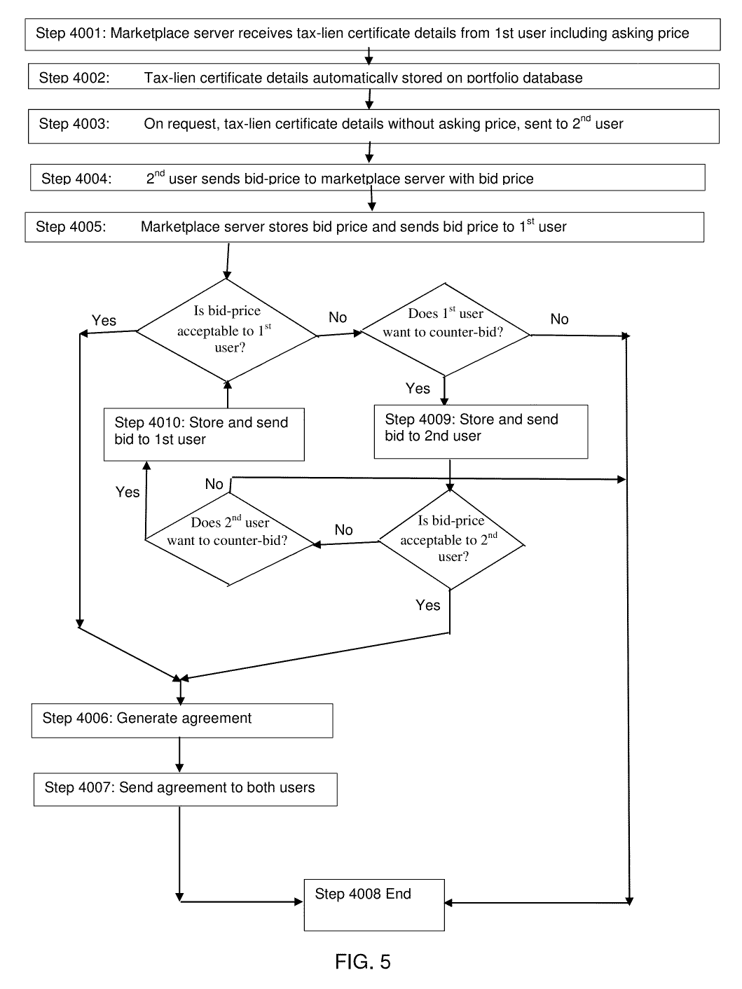

FIG. 5 shows a flow diagram of an exemplary computer implemented method for providing an electronic, online, secondary marketplace for the auction of tax lien certificates.

In Step 4001: Marketplace server receives tax-lien certificate details from 1st user including asking price.

The first user may be, or be an authorized agent, of a beneficial owner of the particular tax-lien certificate. The details of the tax-lien certificate 250 may be received by a marketplace server 210 that may be functionally connected to a portfolio database 220 and to a communications network 280. These details may include information such as, but not limited to, an amount of taxes, penalties, premiums and interest currently due 310 to the beneficial owner on redemption of the certificate, an interest rate associated with the tax-lien certificate, a location of a property 260 on which the certificate is secured, an expiry date of a redemption period and a first asking price to buy the tax-lien certificate. The information may further include other information such as, but not limited to, details concerning the beneficial owner of the property that is collateral, assessments of the value of that property and any other information that may be relevant to a valuation of the tax-lien certificate 250.

In Step 4002: Tax-lien certificate details automatically stored on portfolio database, the marketplace server 210 may store the details regarding the tax-lien certificate 250 it may have received on one or more portfolio databases 220.

In Step 4003: On request, tax-lien certificate details without asking price, sent to 2nd user, the marketplace server 210 may deliver a summary of the certificate details to a second user, on request from the second user. The summary may, for instance, be sent via the communications network 280 and may include information such as, but not limited to, an amount of taxes, premiums, penalties and interest currently due to the beneficial owner on redemption of the tax-lien certificate, an interest rate associated with the tax-lien certificate and a location of a property on which said particular tax-lien certificate is secured.

In a preferred embodiment of the present invention, the second user may not initially be sent the price at which the first user has indicated they are willing to sell.

In Step 4004: 2nd user sends bid-price to marketplace server with bid price, the marketplace server 210 may be a bid price at which that party is interested in acquiring the tax-lien certificate.

In Step 4005: Marketplace server stores bid price and sends bid price to 1st user, the marketplace server 210 may first store the bid price in a suitable electronic form on the portfolio database 220. The marketplace server 210 may then automatically convey bid price to the first user via the communications network 280.

If the first bid price is acceptable to said first user, the process may then proceed to step 2006.

In Step 4006: Generate agreement, the marketplace server 210 may automatically retrieve a template transaction agreement, customize it with the information it may have stored on the portfolio database 220 regarding the progress of the auction. This transaction agreement may effectively transfer beneficial ownership of the tax-lien certificate at the agreed bid price and may include summary details of the transaction for later verification.

In Step 4007: Send agreement to both users, the marketplace server 210 may send electronic copies of the customized agreement on to both users and may then proceed to step 2008, that may be the end of the process.

If the first bid price is, however, not acceptable to the first user, the first user may then decide whether or not they want to counter-bid.

If the first user decides not to counterbid, the process may then proceed to step 4008 and the auction may end.

If the first user decides to counter bid, then, if the bid is placed within any time constraints that may be in effect, the process may move to step 4009.

In Step 4009: Store and send bid to 2nd user, the marketplace server 210 may receive a further bid, may store information regarding the bid such as, but not limited to, the value of the bid and the time and date it may have been received. This information may, for instance, be stored on the portfolio database 220. The marketplace server 210 may then send the bid, or offer price, and any relevant details to the second user.

The second user may then decide whether to accept the bid price and purchase the tax-lien certificate 250. If they decide to accept the price, the process may move to step 4006 and continue on as described above.

If the second user decides not to accept the offer, they may then decide if they want to counter-bid or not. If the second user decides not to counter bid, the process may then move to step 4008 and the auction may end.

If the second user decides to counter-bid, the process may then proceed to step 4010.

In Step 4010: Store and send bid to 1st user, the marketplace server 210 may receive a further bid, may store information regarding the bid such as, but not limited to, the value of the bid and the time and date it may have been received. This information may, for instance, be stored on the portfolio database 220. The marketplace server 210 may then send the bid, or offer price, and any relevant details to the first user.

The process may then proceed to the decision described above after step 4005, and continue in the same fashion until either the parties agree on a price, or one of the parties decides not to counter-bid, or loses the opportunity to counter-bid or accept an offer by delaying their decision longer than a pre-agreed length of time.

In addition to the auction process, the marketplace server 210 may be used for other related tasks such as, but not limited to, gathering lien-relevant data from one or more 3rd party data bases 290 and electronically storing that lien-relevant data on the portfolio data base.

Such lien-relevant data may include, but is not limited to, an estimated current market value of the property on which the tax-lien certificate is secured, redemption-beneficiary data such as, but not limited to, an identity of any party, or parties, having a mortgage-lien on the property 225 and/or any party or parties having a mortgage on said property 235.

The marketplace server 210 may also or instead be used to gather lien-relevant data further such as, but not limited to, state legal-data relevant, in a particular jurisdiction 215, to tax-liens and state data relevant to property foreclosure.

In a preferred embodiment, an investment facilitating company 222 may decide to operate such that the purchase of a membership, or the payment of a fee by a user, confers a member-user status on that user. Member-user status may, for instance, provide access to lien-relevant data not available to a user not having member-user status.

In a further, preferred embodiment, the marketplace server 210 may operate a valuation module that automatically obtains a relevant valuation subset of the lien-relevant data from the portfolio database 220 and uses it to calculate a market value for one or more tax-lien certificates. This valuation may, for instance, only be provided to users having member-user status.

The lien-relevant data gathered by the marketplace server 210 may also or instead include auction information such as, but not limited to, the date of an up-coming auction, the place where the auction will occur and a list of properties in default that may be auctioned at the auction. In addition, the valuation module may automatically calculate a projected market value for a lien-certificate one or more of the properties in default based on a hypothetical auction bid and an assumed redemption date. This calculation may, for instance, be provide a suggested auction bid that may only be available to member-users.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1: A computer implemented method for providing an electronic, online, secondary marketplace for tax liens, comprising:
providing a marketplace server, functionally connected to a portfolio database and to a communications network;
receiving, by said marketplace server via said communications network, from a first user, certificate details of a particular tax-lien certificate, said first user being an authorized agent or a beneficial owner of said particular tax-lien certificate, said certificate details comprising an amount of taxes, penalties, premiums and interest currently due to said beneficial owner on redemption of said particular tax-lien certificate, an interest rate associated with said particular tax-lien certificate, a location of a property on which said particular tax-lien certificate is secured, an expiry date of a redemption period of said tax-lien certificate, and a first asking price to buy said particular tax-lien certificate;
automatically storing, by said marketplace server, said details of said particular tax-lien certificate on said portfolio database;
delivering, by said marketplace server via said communications network, to a second user on request from said second user, summary details of said certificate details, said summary details comprising an amount of taxes and interest currently due to said beneficial owner on redemption of said particular tax-lien certificate, an interest rate associated with said particular tax-lien certificate, a location of a property on which said particular tax-lien certificate is secured;
receiving, by said marketplace server and said communications network, from said second user, a first bid price for said particular tax-lien certificate and storing said bid price in electronic form on said portfolio database;
automatically conveying, by said marketplace server via said communications network said bid price to said first user; and
if said first bid price is acceptable to said first user:
automatically generating, by said marketplace server, a transaction agreement effectively transferring beneficial ownership of said particular tax-lien certificate comprising the agreed bid price and said summary details; and
automatically, electronically transmitting, by said marketplace server via said communications network, an electronic copy of said transaction agreement to each of said users, and automatically storing, by said marketplace server said transaction agreement on said portfolio database.

2: The method of claim 1, further comprising, if said first bid price is not acceptable to said first user, performing the following steps:
a) receiving, by said marketplace server via said communications network, a further offer price from said first user;
b) automatically storing, by said marketplace server, said further offer price on said database;
c) automatically sending, by said marketplace server via said communications network, said further offer price to said second user;
d) if said further offer price is unacceptable, receiving, by said marketplace server and said communications network, from said second user, a further bid price;
e) automatically storing, by said marketplace server, said further bid price on said database;
f) automatically sending, by said marketplace server via said communications network, said further bid price to said first user; and
g) repeating steps “a” to “g” until said first user finds said further bid price acceptable, or said second user finds said further offer price acceptable, or either of said users decides to stop participating in attempting to reach an agreement.

3: The method of claim 2, further comprising gathering lien-relevant data from one or more 3rd party data bases and electronically storing said lien-relevant data on said portfolio data base.

4: The method of claim 3, wherein said lien-relevant data comprises an estimated current market value of said property on which said tax-lien certificate is secured and redemption-beneficiary data comprising an identity of a party having a mortgage-lien on said property and/or a party having a mortgage on said property.

5: The method of claim 3, wherein said lien-relevant data further comprises state legal-data relevant, in a particular jurisdiction, to tax-liens and state data relevant to property foreclosure.

6: The method of claim 5, wherein purchase of a membership, or payment of a fee by a user, confers a member-user on said user, and wherein said member-user status provides access to lien-relevant data not available to a user not having member-user status.

7: The method of claim 6 further comprises a valuation module, operable on said marketplace sever and wherein said valuation module automatically obtains a valuation subset of said lien-relevant data from said portfolio database and wherein said valuation module uses said valuation subset to calculate a market value for one or more tax-lien certificates, and provides said market value to said user having member-user status.

8: The method of claim 7 wherein said lien-relevant data further comprises auction information comprising an auction date of an up-coming auction, a place of said up-coming auction and at least one property in default to be auctioned at said auction, and wherein said valuation module automatically calculates at least one projected market value for a future lien-certificate on said property in default based on at least one hypothetical auction bid and at least one hypothetical redemption date, and provides said projected market value, said hypothetical auction bid and said hypothetical redemption date to a member-user.

9: A computer based system for providing an electronic, online, secondary marketplace for tax liens, comprising:
a marketplace server, functionally connected to a portfolio database and to a communications network, and having one or more programmed modules comprising instructions that enable said marketplace server to perform actions comprising the following acts:
receiving, via said communications network, from a first user, certificate details of a particular tax-lien certificate, said first user being, or being an authorized agent of a beneficial owner of said particular tax-lien certificate, said certificate details comprising an amount of taxes, penalties, premiums and interest currently due to said beneficial owner on redemption of said particular tax-lien certificate, an interest rate associated with said particular tax-lien certificate, a location of a property on which said particular tax-lien certificate is secured, an expiry date of a redemption period of said tax-lien certificate, and a first asking price to buy said particular tax-lien certificate;
automatically storing said details of said particular tax-lien certificate on said portfolio database;
delivering, via said communications network, to a second user on request from said second user, summary details of said certificate details, said summary details comprising an amount of taxes and interest currently due to said beneficial owner on redemption of said particular tax-lien certificate, an interest rate associated with said particular tax-lien certificate, a location of a property on which said particular tax-lien certificate is secured;
receiving, via said communications network, from said second user, a first bid price for said particular tax-lien certificate and storing said bid price in electronic form on said portfolio database;
automatically conveying, by said marketplace server and said communications network said bid price to said first user; and
if said first bid price is acceptable to said first user:
automatically generating a transaction agreement effectively transferring beneficial ownership of said particular tax-lien certificate comprising the agreed bid price and said summary details; and
automatically, electronically transmitting via said communications network, an electronic copy of said transaction agreement to each of said users, and automatically storing, by said marketplace server said transaction agreement on said portfolio database.

10: A method for providing an electronic, online, secondary marketplace for tax liens, comprising:
providing a marketplace server, functionally connected to a portfolio database and to a communications network;
receiving, by said marketplace server via said communications network, from a first user, certificate details of at least one tax-lien certificate, said first user being a beneficial owner, or being an authorized agent of a beneficial owner of said particular tax-lien certificate, said certificate details comprising at least one of an amount of taxes, penalties, premiums, interest currently due to said beneficial owner on redemption of said particular tax-lien certificate, an interest rate associated with said particular tax-lien certificate, a location of a property on which said particular tax-lien certificate is secured, an expiry date of a redemption period of said tax-lien certificate, or a first asking price to buy said particular tax-lien certificate;
automatically storing, by said marketplace server, said details of said particular tax-lien certificate on said portfolio database;
delivering, by said marketplace server via said communications network, to a second user on request from said second user, summary details of said certificate details, said summary details comprising at least one of an amount of taxes and interest currently due to said beneficial owner on redemption of said particular tax-lien certificate, an interest rate associated with said particular tax-lien certificate, a location of a property on which said particular tax-lien certificate is secured;
receiving from said second user, a first bid price for said particular tax-lien certificate and storing said bid price in electronic form on said portfolio database;
conveying, by said marketplace server via said communications network said bid price to said first user; and
if said first bid price is acceptable to said first user an electronic transaction agreement to each of said users.

11: The method of claim 10, further comprising gathering lien-relevant data from one or more 3rd party data bases and electronically storing said lien-relevant data on said portfolio data base.

12: The method of claim 11, wherein said lien-relevant data comprises an estimated current market value of said property on which said tax-lien certificate is secured and redemption-beneficiary data comprising an identity of a party having a mortgage-lien on said property and/or a party having a mortgage on said property.

13: The method of claim 11, wherein said lien-relevant data further comprises state legal-data relevant, in a particular jurisdiction, to tax-liens and state data relevant to property foreclosure.

14.: The method of claim 10, wherein the user obtains a membership, wherein said member-user status provides access to lien-relevant data not available to a user not having member-user status.

15: The method of claim 10 further comparing a valuation module, operable on said marketplace sever and wherein said valuation module automatically obtains a valuation subset of said lien-relevant data from said portfolio database and wherein said valuation module uses said valuation subset to calculate a market value for one or more tax-lien certificates, and provides said market value to said user having member-user status.

16: The method of claim 11 wherein said lien-relevant data further comprises auction information comprising an auction date of an up-coming auction, a place of said up-coming auction and at least one property in default to be auctioned at said auction, and wherein said valuation module automatically calculates at least one projected market value for a future lien-certificate on said property in default based on at least one hypothetical auction bid and at least one hypothetical redemption date, and provides said projected market value, said hypothetical auction bid and said hypothetical redemption date to a member-user.
